(19) United States
(12) Patent Application Publication
(10) Pub. No.: US 2011/0016396 A1
(43) Pub. Date: Jan. 20, 2011

(54) CONTENT MEDIA REPRODUCTION DEVICE AND CONTENT MEDIA

(75) Inventor: Tomoaki Maruyama, Tochigi (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/922,212

(22) PCT Filed: Jan. 29, 2010
(86) PCT No.: PCT/JP2010/000544

§ 371 Date: Sep. 13, 2010

(30) Foreign Application Priority Data
Feb. 13, 2009 (JP) 2009-031909

(51) Int. Cl. G06F 3/01

(52) U.S. Cl. 715/716

(57) ABSTRACT

Disclosed that a content media playback apparatus enables creation of viewing histories serving many uses even for complex content like a BD-Java-ready Blu-ray disc and so forth in which playback of moving images and so forth is controlled by a program. Viewing history generating section (1009) generates a viewing history (1011) using times the program content processing section changes the states described in the viewing history template and the states. A viewing history template describes states and transitions between the states that should be recorded as viewing history elements of video and sound contents.

### TECHNICAL FIELD

The present invention relates to a content media playback apparatus and content media, and relates to a content media playback apparatus and content media that acquire viewing histories of, for example, a DVD (formal and standard name) player, a Blu-ray (formal and standard name) disc player.

### BACKGROUND ART

In recent years, audio visual (AV) home electric appliances such as televisions, video players, cable television receivers (cable televisions, set-top boxes) and so forth have become increasingly Internet (registered trademark)-ready, and therefore, in addition to conventional watching of broadcast and video contents, Internet services are provided through AV home electric appliances. For example, users can enjoy Internet services while watching televisions, by using services such as VIERACast by Panasonic Corporation and AppliCast (registered trademark) by Sony Corporation.

Likewise, users can enjoy Internet services when playing back a Blu-lay disc compliant with BL-LIVE (standard name), on a Blu-ray disc player compliant with BL-LIVE.

To be more specific, the user is able to acquire, from the Internet, information about the actor appearing on the currently received television program and display it on the television screen, or purchase movies, music and so forth related to the television program, through the Internet. In addition, the user is able to download a bonus movie such as movie-making images related to a video movie disc that is played back and viewed.

As described above, now, mechanisms in home electric appliances and infrastructures such as optical fibers to provide internet services through home electric appliances are nearing completion, but it is difficult to say that these services and their functions are widely used by users.

There are some possible causes of blocking of user's accesses to use. One of those is that home electric appliances are not convenient because the degree of freedom of user input is low, as compared to personal computers or Internet-ready mobile telephones.

For example, when intending to purchase a video disc of an interested movie using a personal computer, the user may input, through the keyboard, the title of the movie that the user wants on an online shopping site, select the video disc from a plurality of candidates presented by the online shop using the mouse and then make payments. By contrast with this, Internet-ready televisions do not have a character input means like a keyboard. Therefore, the user has to perform input operations through a remote controller instead of a character input means and is exhausted before arriving at the product that the user wants.

In order to solve this problem, it is preferred that televisions are equipped with television input devices allowing character input or pointing, but this requires modification and addition of hardware are required, so that the cost of home electric appliances is increased and it is not necessarily a good plan.

Therefore, by changing the idea, a method of improving convenience for users by reducing complex user inputs, is possible. That is, convenience for the user is improved by guessing the user's preference or wish by home electric appliances in order to allow the user to enjoy services that the user wants only by minimum inputs.

There are various methods to guess the user's preference and wish. Among them, for a television or video disc player, a method of acquiring and statistically analyzing the user's viewing history of an AV home electric appliance, is important.

For example, as a simple example, if it is known that a user mainly watches baseball game programs on television, it is possible to guess that the user likes baseball. As a result of this, when the user intends to select pay-TV such as cable television, the service provider side recommends several channels of baseball game programs, so that the user is often able to save the trouble of bothering to select the desired channel among many channels.

Patent-Document 1 discloses a typical means for collecting viewing histories. The collecting means disclosed in Patent-Document 1, first, records a remote controller signal with information of the time a key of the remote controller of the television is pressed. Then, a viewing history is generated by combining a log of these remote controller signals and program information obtained separately.

Then, the user's preference and so forth may be analyzed using viewing histories obtained as described above. For example, Patent-Document 2 discloses a method of analyzing collected viewing histories (“watching trend analysis” as a term in Patent-Document 2.)

As described above, if a viewing history of a user is generated and acquired in some form, home electric appliances make it possible to automatically provide services according to the user's preference or wish by analyzing viewing history information. Therefore, in order to analyze preference accurately in detail, it is naturally important to improve of the analysis method itself, in addition, it is important to acquire correct and detailed user's viewing histories.

### Citation List

Patent Literature

PTL 1 Patent 2004-248201 (claims 1 and 2 in page 2,and FIG. 3)

PTL 2 Patent 2005-352754 (examples in pages 15 to 19)

### SUMMARY OF INVENTION

### Technical Problem

In case of broadcast such as television, cable television or cable broadcast, it is possible to clarify what scene in the content is played back, only by designating the channel and the time. Therefore it is possible to record a viewing history quite accurately in detail only by recording the user's operation on a television with the time. Then, it is possible to nearly completely read the user's operations on a television from operation button presses on a television or key presses on the remote controller.

By contrast with this, a video player (DVD player or Blu-ray disc player) unlike. broadcast does not provide a program list and so forth. Therefore, it is significantly difficult to, for example, guess what title of the video content and what scene the user viewed, from the user's operation on the remote controller and the time.

Therefore, in order to automatically record viewing histories in a video player, the video player needs to be able to acquire at least meta-information such as the title or content configuration of video content. For example, it is possible to record, on a viewing history, at least the user has viewed the video content of a title as long as a video player knows the title of the video content. In addition, a video player also records its key operations (playback, fast-forward, stop and so forth), so that it is possible to record detailed information, such as how long and how many times the user viewed a certain part of the video content of this title, in the viewing history. By this means, the quality of the viewing history may be improved to some extent.

However, in recent years, a standard has appeared that allows control of playback of video and sound contents such as a BD-live-ready Blu-ray disc content, which is recorded on a disc, by a complex program. Although, in this case, the user can operate to play back contents using conventional operation keys (playback, fast-forward, stop and so forth), another case has been known that allows operations of contents through GUI (graphical user interface) windows, in addition to use of these operation keys. In addition, a case may be possible where a program providing the above-described GUI windows is not only used in playback control but also is content itself. Games, multi-ending stories and so forth are typical examples.

However, when a program itself that provides GUI windows, is content, the number of operation keys each having a unique meaning at all times is reduced, so that it is difficult to know what the user was doing only by simply recording the user's key operations. Therefore, it is often difficult to create a viewing history.

It is therefore an object of the present invention to provide a content media playback apparatus and content media that enable creation of viewing histories serving many uses even for complex content like a BD-Java-ready Blu-ray disc and so forth in which playback of moving images and so forth is controlled by a program.

### Means for Solving the Problem

The content media playback apparatus according to the present invention plays back content media composed of video and sound contents and a program content including a user interface that presents the video and sound contents, the content media playback apparatus adopts a configuration to include: an access section that reads the content media; an input section that accepts an operation input from a user; a program content processing section that reads the program content from the access section and controls playback of the video and sound contents by operating the program content according to the operation input; a recording section that records a viewing history template to describe states of the program content processing section and links between the states that should be recorded as viewing history elements of the video and sound contents; and a generating section that generates the viewing history elements using times the program content processing section changes the states described in the viewing history template and the states.

The content media according to the present invention adopts a configuration to include: video and sound contents; a program content that includes a user interface presenting the video and sound contents; and a viewing history template that describes states and transitions between the states that should be recorded as viewing history elements of the video and sound contents, among states of a content media playback apparatus that plays back the video and sound contents and transitions between the states.

### Advantageous Effects of Invention

According to the present invention, it is possible to create detailed viewing histories with a large amount of information for content media composed of video and sound contents and a program content including a user interface (UI) that presents these video and sound contents, like, for example, a BD-Live-ready Blu-ray disc and a Flash (trademark) content from Adobe Systems Incorporated. Then, analysis by pairing a viewing history and a viewing history template enables mechanical analysis of viewing histories and is useful for large-scale analysis of viewing histories using computers.

### BRIEF DESCRIPTION OF DRAWINGS

FIG. 1 is a configuration diagram showing an optical disc player and an optical disc according to Embodiment 1 of the present invention;

FIG. 2 is a state transition diagram representing the content of a program according to Embodiment 1;

FIG. 3A is a drawing showing an exemplary viewing history template according to Embodiment 1;

FIG. 3B is a drawing showing another exemplary viewing history template according to Embodiment 1;

FIG. 4 is a flowchart explaining a method of creating a viewing history according to Embodiment 1;

FIG. 5 is a drawing an exemplary Java program in the program content according to Embodiment 1;

FIG. 6 is an exemplary viewing history according to Embodiment 1;

FIG. 7 is an action diagram resulting from analyzing the viewing history according to Embodiment 1;

FIG. 8 is a drawing showing an exemplary Java program according to Embodiment 3 of the present invention;

FIG. 9 is a schematic diagram showing representations on a display resulting from operating the program content according to Embodiment 3;

FIG. 10 is a drawing showing exemplary bytecodes of the Java program according to Embodiment 3;

FIG. 11 is a flowchart explaining a method of automatically creating a viewing history template according to Embodiment 3; and

FIG. 12 is a drawing showing an example of a created viewing history template according to Embodiment 3.

### BEST MODE FOR CARRYING OUT THE INVENTION

Now, embodiments of the present invention will be described in detail with reference to the accompanying drawings.

### Embodiment 1

The present embodiment is a basic example of the present invention. Now, a viewing history creating method will be described using a case as an example where the user plays back certain content media using a content media playback apparatus. Now, a case will be described as an example where the present invention is applied to an optical disc such as a DVD, a Blu-ray disc and so forth as content media, and applied to an optical disc player as a content media playback apparatus.

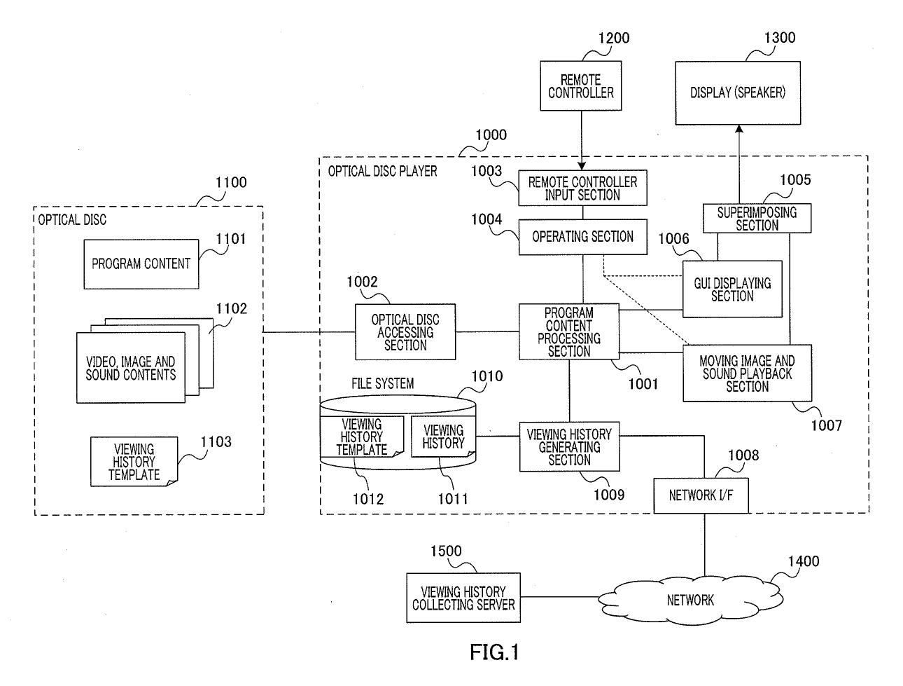

First, FIG. 1 is a block diagram showing components inside the optical disc player and the optical disc according to Embodiment 1.

Optical disc player 1000 is an apparatus that can play contents on the optical disc and execute the program content on the optical disk. Optical disc player 1000 operates in accordance with elements of the program content and in accordance with input from remote controller 1200 held by the user. Video and sound of played back contents or graphic display resulting from executing the program content are represented by display (and speaker) 1300.

Remote controller input section 1003 receives inputs from remote controller 1200 and sends them to operating section 1004. Operating section 1004 converts electrical signals inputted from remote controller 1200 into input events (typically, key event, mouse event and so forth) in programming languages allowed to be processed in program content processing section 1001, GUI (graphical user interface) display section 1006 and moving image and sound playback section 1007.

Program content processing section 1001 reads the program content in optical disc 1100 through optical disc access section 1002 and displays a GUI (graphical user interface) on display (and speaker) 1300 with support from GUI display section 1006, in accordance with the read program content and a user input from the remote controller (key event). In addition, program content processing section 1001 waits for a user input from the remote controller (key event) or gives a command to moving image and sound playback section 1007 to represent video and sound contents on display (and speaker) 1300. Operations of this program content processing section 1001 will be described in detail later.

Optical disc player 1000 has file system 1010 as a general-purpose storage device to store various information, and each section of optical disc player 1000 can access, read from, and write in file system 1010.

File system 1010 is a storage device, and viewing history template 1012 and viewing history 1011 are written in file system 1010 at the appropriate time. Viewing history generating section 1009 reads and writes this viewing history 1011.

Moreover, if necessary, viewing history generating section 1009 can upload that viewing history 1011 to history collecting server 1500 provided outside optical disc player 1000 via network I/F (interface) 1008.

Network 1400 collectively refers to the home local area network and the Internet between optical disc player 1000 and history collecting server 1500 for ease of explanation.

Meanwhile, optical disc 1100 has program content 1101, video, image and sound contents 1102, and viewing history template 1103, and optical disc player 1000 can read these via optical disc access section 1002.

Program content 1101 is an application described in some programming language, controls playback of video, image and sound contents (or video and sound contents) 1102 and displays a GUI to the user. In addition, a case in which program content 1101 itself is content for the user such as a game, is possible.

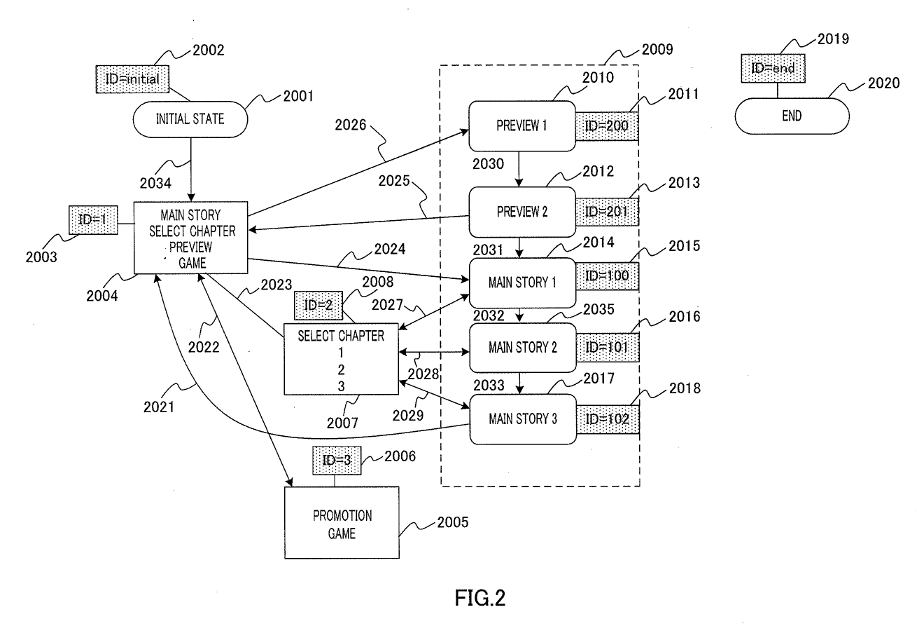

Elements of program content 1101 according to the present embodiment will be described separately in detail with reference to FIG. 2.

Video, image and sound contents 1102 are still images, movies, sound and so forth and are narrowly-defined contents scheduled to be sequentially played back over time.

When the subject matter of optical disc 1100 is a movie, the movie itself becomes content. In addition, when optical disc 1100 is like a photo album, photographs themselves are content, and a program to list and display these photographs and display them as slideshow becomes program content.

The present embodiment will be described using a case as an example where the subject matter of optical disc 1100 is a movie, and video, image and sound contents 1102 become the main story of the movie itself and the preview itself.

FIG. 2 is a state transition diagram schematically representing elements of program content 1101. The actual program content is compiled from a programming language for efficient processing in program content processing section 1001, but is represented here schematically as shown FIG. 2 because it is difficult to understand by human. Each state in FIG. 2 will be explained in the course of the following descriptions.

Here, the present embodiment assumes Java (which is the name of a programming language and which is the registered trademark) as the description language of program content 1101. Therefore, program content processing section 1001 is one of Java processors (VMs: Virtual Machines).

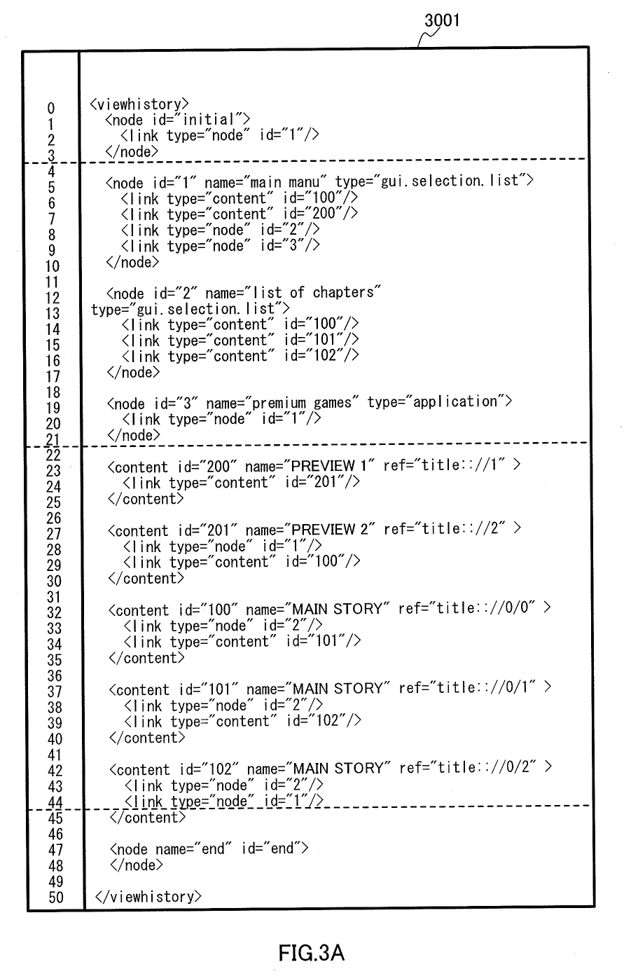

FIG. 3A shows specific content of viewing history template 1103 (or 1012).

Each of viewing history template 3001 in FIG. 3A and viewing history template 3002 in FIG. 3B is equivalent to viewing history template 1103 (or 1012) expressed by XML (eXtensible Markup Language). Here, row numbers in the left side of viewing history templates 3001 and 3002 are added for ease of explanation and are not included in actual viewing history template 1103 (or 1012).

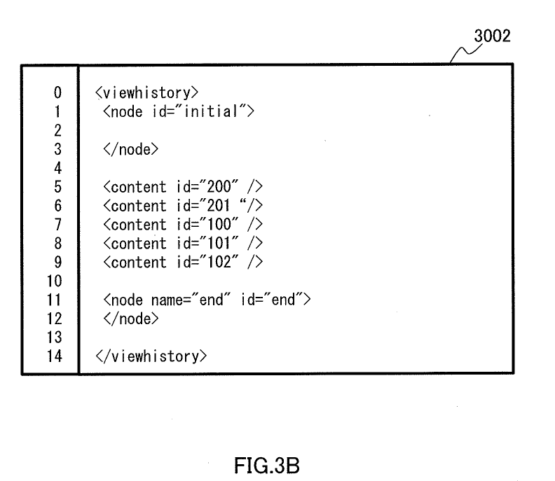

FIG. 4 is a flowchart representing parts related to viewing history generation, among operations of program content processing section 1001.

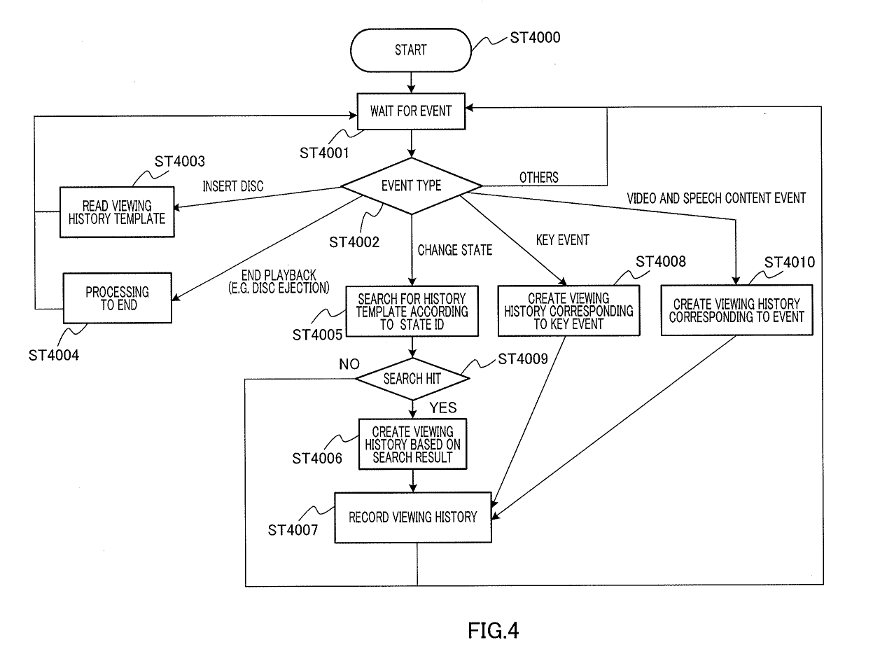

FIG. 5 shows an exemplary program content 1101. In order to explain the processing to find the timing of viewing history generation in the process of processing and executing program content 1101 by content processing section 1001 program content 1101 in FIG. 5 is expressed in the Java language. Here, the example shown in FIG. 5 is very simplified for ease of explanation. Therefore, the content expressed in the Java language in FIG. 5 is completely different from FIG. 2.

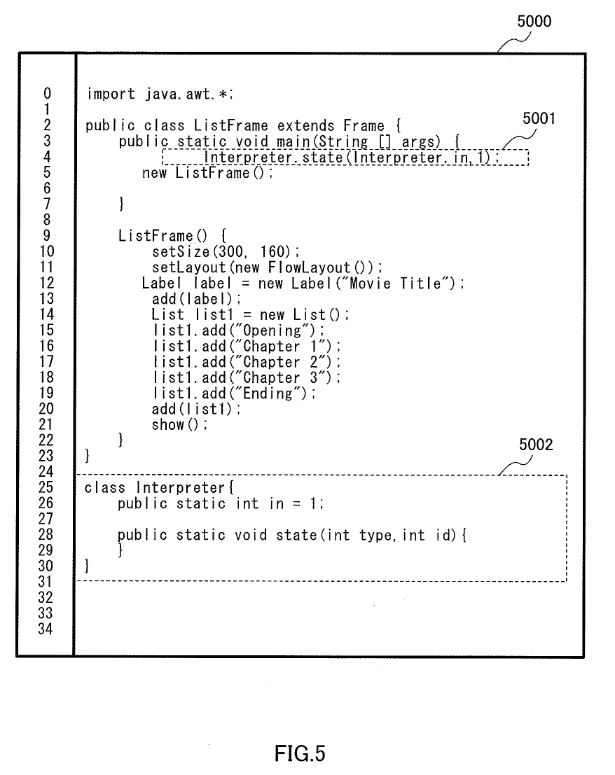

FIG. 6 shows viewing history 1011 that is finally created in the present embodiment. Here, row numbers in the left side of viewing history 6001 shown in FIG. 1 are added for ease of explanation, and are not actually included in viewing history 6001.

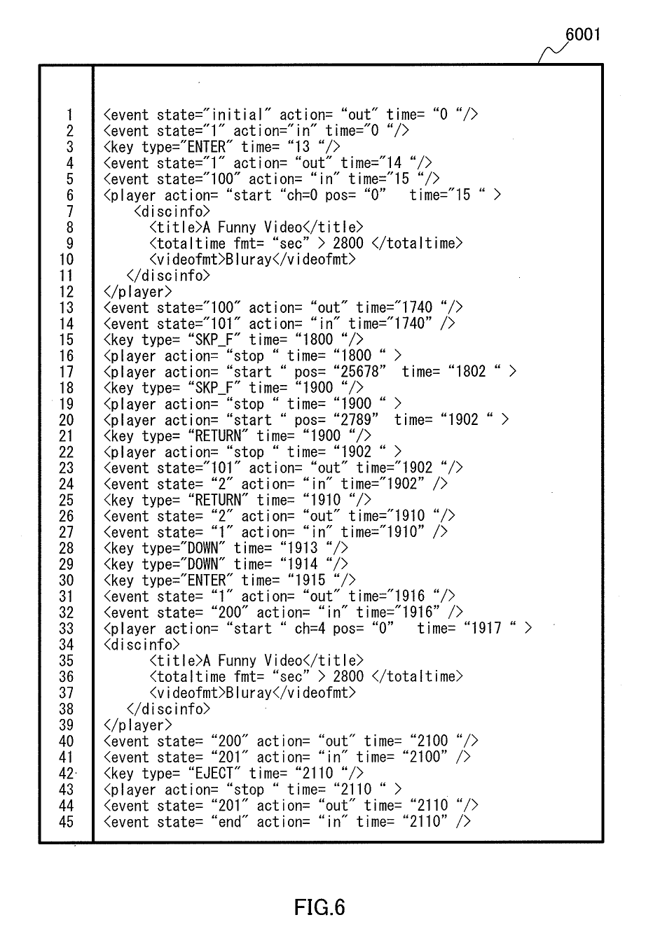

FIG. 7 is a drawing represented by superimposing the result of the analysis by comparing viewing history 6001 represented as FIG. 6 against viewing history template 3001, on the state transition diagram of FIG. 2.

Now, operations of optical disc player 1000 will be described with reference to the above-described FIG. 1 to FIG. 7.

Assume that, now, optical disc 1100 is inserted in optical disc player 1000. In the same way as in a general Blu-ray disc player, when optical disc 1100, a content disc, is inserted to optical disc player 1000, the content of optical disc 1100 is automatically read, and playback of the content starts.

According to the present embodiment, program content processing section 1001 reads contents of optical disc 1100, that is, program content 1101, video, image and sound content 1102 and viewing history template 1103, using optical access section 1002 and copies viewing history template 1103 to file system 1010 as viewing history template 1012.

Next, program content processing section 1001 starts executing program content 1101. Although program content 1101 is actually a collection of compiled Java program bytecodes, the following descriptions will use the state transition diagram of FIG. 2 that is theoretically equivalent to a Java program for ease of explanation. Here, this state transition diagram of FIG. 2 is very simplified. In addition, program content processing section 1001 is actually a Java VM, but is described as a state transition machine for ease of explanation.

In FIG. 2, white squares and rounded squares represent main states of program content 1101. In addition, in FIG. 2, arrows represent transition possibilities between each state. Actually, state transitions are caused by some triggers (transition conditions, including user inputs, timer signals, hardware interrupt and so forth). Otherwise, state transitions occur without conditions even if there is no trigger (transition condition). Here, triggers for state transitions (transition conditions) are omitted in FIG. 2.

Moreover, there is no arrow toward end state 2020 because it is possible to move to end state 2020 from any state, so that arrows are omitted to prevent the figure from being complex.

In FIG. 2, shaded squares (2002, 2003, 2008, 2006, 2011, 2013, 2015, 2016, 2018, 2019) represent the names of states, respectively. In the embodiment, these names are referred to as “state IDs” or simply “IDs,” and FIG. 2 is an example in which names are expressed by numbers. Note that the initial state and the end state have special names, “initial” and “end”, respectively. Here, dashed-line square 2009 represents a group of states. State group 2009 will be described later.

Now, when optical disc 1100 is inserted, program content processing section 1001 varies its states according to program content 1101, that is, according to the state transition diagram of FIG. 2.

Immediately after starting from initial state 2001 (ID=initial), program content processing section 1001 moves to state 2004 (ID=1) without conditions. In this state, program content processing section 1001 displays the main menu screen on display 1300 and waits for selecting input from the user. Elements of the content of optical disc 1100 is displayed on the main menu screen in the form of a list. Here, the user can select “play back main story of movie,” “select chapter of main story ” “play back preview” or “game.” from the menu.

Then, if wanting to see the main story of a movie soon, the user selects “play back main story of movie” in the list displayed on display 1300 by operating remote controller 1200. By this selecting operation, a remote controller signal is transmitted to program content processing section 1001, as a key event, via remote controller input section 1003 and operating section 1004. When program content processing section 1001 properly interprets that key event, transition of link 2024 occurs, and the state of program content processing section 1001 moves to state 2014 (ID=100) to play back chapter 1 of the main story. Then, program content processing section 1001 commands moving image and sound playback section 1007 to play back the main story of the movie, so that the main story of the movie is played back.

Hereinafter, likewise, program content 1101 is executed in program content processing section 1001 by changing the internal state in response to key events from the user and executing actions corresponding to states.

How a viewing history is created in the case like this will be described.

If only key events are recorded, only “up and down keys” to view a GUI list displayed on display 1300, “selection key” to select one in the list and so forth are recorded, and, when a third party acquires a sequence of these keys and attempts to analyze the viewing history, he/she cannot understand the meaning at all. Moreover, even if program contents are the same, GUI representation and key events are different depending on playback devices, so that it is not even possible to have a guess.

By contrast with this, with the present embodiment, a viewing history is generated using a viewing history template. The viewing history creating method according to the present embodiment is as follows.

First, a viewing history template is defined as below. A viewing history template is a collection obtained by extracting states desired to be recorded as viewing history elements from all states when the program content is regarded as a logically equivalent state transition diagram. Then, it is possible to add information including links to other states, names explaining states, descriptions explaining actions executed in corresponding states and so forth, to states contained in the viewing history template.

With the present embodiment, a case will be described as an example where this viewing history template is described in XML form as shown in FIG. 3A and FIG. 3B. Here, viewing history templates are not necessarily in XML form and there is no problem if viewing history templates are represented in other forms.

FIG. 3A and FIG. 3B show two viewing history templates 3001 and 3002. Both of these viewing history templates 3001 and 3002 are created for program content 1101 (or the state transition diagram of FIG. 2). Viewing history template 3001 is a template to acquire viewing history elements for all states and is enhanced with additional information such as links and names, that is, a full set of viewing history template.

As understood by closely looking at viewing history template 3001, the content of viewing history template 3001 is almost the same as in the state transition diagram of FIG. 2. A viewing history template includes states and links between states as additional information, so that when a full set of viewing history template 3001 is used, the resulting viewing history is naturally equivalent to the corresponding state transition diagram.

Meanwhile, viewing history template 3002 is a template to acquire viewing history elements within a range of state group 2009 of FIG. 2, that is, only within the playback range of the video content (movie preview and main story) and lacks additional information completely. When viewing history template 3002 is used, the resulting viewing history is equivalent to a list of state IDs that the user wants to acquire.

Naturally, viewing history template 3001 has a larger amount of information than viewing history template 3002, so that it is possible to acquire more knowledge when the viewing history is analyzed later. However, it takes more trouble to create viewing history template 3001 than viewing history template 3002.

With the present embodiment, a case will be described as an example where program content processing section 1001 uses a full set of viewing history template 3001.

Now, program content processing section 1001 having viewing history template 3001 processes and executes program content 1101 while creating viewing histories according to the flowchart as shown in FIG. 4.

Now, assume that the user acts in the order shown below and views this optical disc 1100.

(Action #1) The user looks at the main selection screen (state 2004; ID=1) and selects playback of the main story (state 2014; ID=100) (Action #2) The user watches the main story for a while, and in the middle of chapter 2 of the main story (state 2035; ID=101), operates remote controller 1200 to move to the chapter selecting screen (state 2007; ID=2). (Action #3) In addition, the user returns to the main selection screen (state 2004; ID=1). (Action #4) The user moves to preview 1 (state 2010; ID=200) and watches preview 1. (Action #5) Subsequently, the user watches preview 2 (state 2012; ID=201), and in the middle of this, executes “disc ejection” to finish watching (state 2020; ID=end).

Here, FIG. 6 shows a viewing history created based on these actions.

First, program content processing section 1001 passes through start ST 4000 and enters ST 4001 for waiting for an event. Here, events are key events from the user, hardware interrupts, timer events and so forth. Note that program content processing section 1001 processes and executes program content 1101 in parallel with the flow shown in FIG. 4.

First, when optical disc 1100 is inserted in optical disc player 1000, a hardware interrupt occurs to report disc insertion, and program content processing section 1001 enters ST 4003 for reading a viewing history template. Here, program content processing section 1001 reads viewing history template 1103 and copies it in file system 1010 as viewing history template 1012. After copying, program content processing section 1001 analyzes viewing history template 1012 described in XML form and adds search indexes and so forth to viewing history template 1012 for later use.

Then, when finishing preparation for viewing history generation, program content processing section 1001 records that the initial state has passed in the viewing history. To be more specific, program content processing section 1001 gives a command to viewing history generating section 1009 to record having passed the initial state. Then, viewing history generating section 1009 newly generates a blank viewing history, and, at its beginning, records a viewing history element with the time (the first row of viewing history 6001).

The first row of viewing history 6001 means that “an event is caused by the user's action (disc insertion; represented by “event” tag), that the corresponding state ID is “initial” (state 2001 and 2002), that this state ends (attribute “out”), and that the generated time stamp is zero second.”

After this, program content processing section 1001 enters ST 4001 for waiting for an event again.

At the same time, program content processing section 1001 displays the main selection screen (state 2004; ID=1) on display 1300 according to program content 1101.

After changing the state from the initial state (state 2001; ID=initial) to the main selection screen (state 2004; ID=1), program content processing section 1001 issues a state change event to itself. Then, upon receiving the state change event, program content processing section 1001 moves from ST 4001 for waiting for an event to ST 4002 for blanching event types and moves to ST 4005, according to the flowchart in FIG. 4. In ST 4005, whether or not this state should be changed is determined with reference to viewing history template 1103.

There is “main menu” representing the state of the main selection screen (state 2004; ID=1) in the fifth to tenth rows of viewing history template 3001, so that search hit in ST 4009 is YES, and program content processing section 1001 enters ST 4006 for creating a viewing history. After this, program content processing section 1001 gives a command to viewing history generating section 1009 to move to ST 4007 and record an appropriate viewing history element (the second row of viewing history 6001), and then enters ST 4001 for waiting for an event again.

Here, how program content processing section 1001 knows that state transition occurs and how the viewing history template creator (a person in usual) knows states and their names (IDs) will be explained.

When a program content is realized as a state transition diagram in an implementation, the state transition diagram is expressly indicated in program descriptions. Therefore, the viewing history template creator can create a viewing history template by looking at the state transition diagram. Then, it may be possible to automate most of this operation. In addition, accordingly, program content processing section 1001 may be realized as a state transition machine in an implementation, so that program content processing section 1001 easily know that state transition has occurred.

By contrast with this, unlike state transition, a programming language like Java language, which is a procedural language, and its implementation do not explicitly define states. Therefore, it is necessary to provide a mechanism to define states and allow program content processing section 1001 to know that state transition occurs and provide a means to allow the viewing history template creator to know all states. As the easiest method, a method is possible where the person who creates a program content defines states and expressly indicates timings of state transitions in program descriptions, and the present embodiment adopts this method.

FIG. 5 shows a very simple Java program representing a list selection screen.

In the Java program 5000 shown in FIG. 5, class 5002 (“class interpreter”) is prepared to issue state transition events to program content processing section 1001. Then, report 5001 to program content processing section 1001 is embedded in the Java program using class 5002.

Class 5002 is actually blank and has no function in program descriptions for the case where program content processing section 1001 does not support viewing history generation. In a case in which program content processing section 1001 supports history creation, when this program is loaded, state( )method in “class interpreter” is written over the original implementation.

Here, a method in which viewing history templates are not created by human but are created automatically will be described with Embodiment 3.

Returning to FIG. 4, viewing history generation will be described again.

Next, the user executes (action #1). That is, the user watches the main selection screen (state 2004; ID=1) and presses “selection key” in remote controller 1200, to select “play back main story ” (state 2014; ID=100).

Upon receiving the key event “selection” (symbol is “ENTER”), program content processing section 1001 records that key event as a viewing history element (the third row of viewing history 6001) and also records the state transition (transition from state 2004 to state 2014) caused by that key event (the fourth and fifth rows of viewing history 6001).

The fourth row of viewing history 6001 represents that the display state (state 2004; ID=1) of the main selection screen ends at time stamp 14. The fifth row of viewing history 6001 represents that the state moves to the state in which chapter 1 of the main story is played back (state 2014; ID=100) at time stamp 15.

Meanwhile, upon entering the state in which chapter 1 of the main story is played back (state 2014; ID=100), program content processing section 1001 commands moving image and sound playback section 1007 to play back chapter 1 of the main story as an action associated with that state. When commanding moving image and sound playback section 1007 to do something, program content processing section 1001 makes moving image and sound playback section 1007 generate a video and sound contents event corresponding to that command, to program content processing section 1001. As a result of this, ST 4010 is executed to record the sixth to twelfth rows of viewing history 6001.

When program content processing section 1001 gives a command to moving image and sound playback section 1007, meta-information, for example, the titles of a video, the time required to record the video, and the format are determined in many cases, so that these pieces of meta-information are recorded at the same time (eighth to tenth rows of viewing history 6001).

Hereinafter, likewise, watching states from (action #2) to (action #5) are recorded, and finally, the viewing history shown in FIG. 6 is created.

Then, when playback of optical disc 1100 is finished (in this case, the user ejects optical disc 1100 (action #5)), this state is recorded (forty-second to forty-fifth rows of viewing history 6001) and viewing history 1011 is closed and saved in a pair with viewing history template 1012.

After that, according to need, this pair of viewing history 1011 and viewing history template 1012 is allowed to be uploaded to history collecting server 1500 and analyzed, or allowed to be used to improve convenience for the user while being held in optical disc player 1000 without being uploaded.

FIG. 7 is a drawing representing viewing history 6001 shown in FIG. 6 in the form of an action diagram like part of the state transition diagram of FIG. 2 visually representing viewing history template 3001.

FIG. 7 shows a scene in which the user starts watching the main story, stops watching chapter 2 on the way because the movie may be boring, watches a preview of another movie a little, and stops this on the way likewise. Note that in order to approach the real intent of the user as much as possible, time stamps, associated key operations, comparison with other viewing histories and so forth may be required.

As described above, with the present embodiment, states of program content processing section 1001, which should be recorded as the viewing history of video and sound contents and links between these states are described in viewing history template 1012, and viewing history generating section 1009 generates viewing history 1011 including the times program content processing section 1001 moves states described in viewing history template 1012 and names of these states.

By this means, it is possible to create a rich and accurate viewing history of content obtained by integrating sound and video contents and a program content (e.g. BD-live-ready Blu-ray disc content and Adobe Flash content). In addition, likewise, it is possible to create viewing histories of Flash contents which conventionally have allowed users to know about only information such as the number of downloads from networks.

Moreover, it is possible to mechanically and uniquely analyze what scene the user watches and how the user watches the scene without arbitrary human interpretation by matching a collected viewing history with a viewing history template, so that large-scale and high-speed viewing history analysis is allowed by computers.

### Embodiment 2

With embodiment 1, a case has been described where a viewing history template is included in an optical disc.

As described with Embodiment 1, a viewing history template is created in parallel with creation of the program content and sound and video contents by a content creator, and they are recorded in the same content media and distributed, so that an optical disc player can reliably read the viewing history template in time with playback of contents.

On the other hand, in a case in which the viewing history templates are allowed to be stored in all optical discs, when the user watches an optical disc on an optical disc player not using a viewing history template, the viewing history template is unnecessary, and when the viewing history that the user wants to record is changed later, it is difficult to do so.

Therefore, it is possible to solve these problems by a configuration in which viewing history templates are placed on a network and an optical disc player downloads the viewing history template from the network when necessary.

For example, a case will be described using FIG. 1 again as an example where, instead of viewing history template 1103, tags being capable of identifying viewing history template 1103 are recorded in optical disc 1100 and history collecting server 1500 records many viewing history templates. At this time, tags are title names of contents, some ID codes and so forth and viewing history template 1103 will be searched from tags.

Then, at the time of playback of optical disc 1100, program content processing section 1001 searches for the viewing history template corresponding to the tag recorded in optical disc 1100 in history collecting server 1500 and downloads the viewing history template via network 1400. Program content processing section 1001 records the downloaded viewing history template on file system 1010 as viewing history template 1012.

By this means, it is possible to use viewing history templates on demand while the same effect as in Embodiment 1 is produced.

### Embodiment 3

With Embodiment 1, although a case has been described where a viewing history template is created in parallel with creation of the program content and sound and video contents by a content creator, and they are recorded in the same content media and distributed, it is possible to create a viewing history template mechanically from the program content and video and sound contents without human hands.

Naturally, as compared to viewing history templates created by human, mechanically-created viewing history templates are limited on the quality of information allowed to be automatically extracted and are partially poorer for analyzing afterward. However, even if there is this problem, the point that it is possible to mechanically and automatically create viewing history templates without human hands is useful from the aspect of efficiency. Moreover, the point that it is possible to acquire a viewing history template of contents not originally supporting viewing history templates, at a certain level of quality, is also useful. Therefore, with the present embodiment, automatic creation of viewing history templates will be described.

Here, how to automatically create a viewing history template will be described. As described with Embodiment 1, in a viewing history template, content configuration and operations are classified for simplification into “important scenes” and “transitions between scenes” of the program content to allow human to understand, and are expressed in a language formed to allow later mechanical analysis.

By contrast with this, although it is possible to convert a general program into a state transition automaton by mechanical procedures, if states of automaton are replaced with states in a viewing history template, the automaton is not necessarily uniquely defined and “important scenes” as described above are not necessarily allowed to be extracted. Therefore, it is necessary to extract “important scenes” from content by introducing some semantic or empirical methods.

With the present embodiment, assume that the language for describing the program content is an object-oriented programming language such as Java, Javascript and so forth. The method of automatically creating viewing history templates according to the present embodiment is based on that the program content is described in an object-oriented language. Although described in detail later, this reason is that the method of automatically creating viewing history templates according to the present invention extracts useful states for human (the above-described “important scenes”) by paying attention to specific classes and methods of an object-oriented language.

First, in a viewing history template, important scenes (states) whose history elements are required are mostly scenes in which the user selects content elements or directly operates content elements (playback, fast-forward, stop and so forth). This is quite natural because information needed in a viewing history is what content element was selected and how the selected content element was operated.

Then, how important scenes including (1) the scene of content element selection and (2) the scene of content element operation are related to the configuration of the program content will be described. Currently, GUI-based software is extremely popular, and therefore the action of the user and the state of the screen or input user interface are closely related to one another. That is, in (1) the scene of content element selection, normally, some candidates to be selected are listed on the screen and the user can input the result selected from these candidates. In addition, in (2) the scene of content element operation, normally, a GUI to operate content elements is displayed on the screen instead of content elements.

Then, currently, object-oriented programming languages are used to describe GUI-based software in most cases and in addition, many of them provide a file referred to as a class library resulting from collecting typical screen displays and user input methods.

Therefore, in (1) the scene of content element selection, and in (2) the scene of content element operation, a certain class (different depending on programming language libraries) is often displayed.

For example, in case of creating the program content of the state transition diagram as shown in FIG. 2 described with Embodiment 1 using a Java AWT (Abstract Window Toolkit) class library, a Java.awt.Frame (hereinafter occasionally abbreviated as

“Frame”) class is normally used to create the outer frame of the window (screen). Then, various classes referred to as “components” are placed in the outer frame of this window (screen).

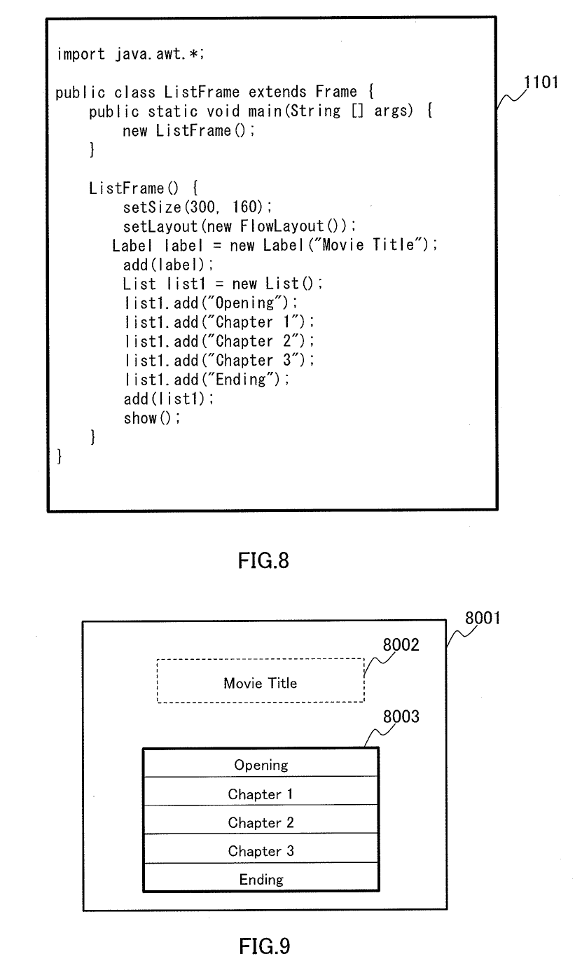

For example, FIG. 9 is a typical example of a selection screen created using Java AWT class library where outer frame 8001 of the window (screen) is created with a frame class, and inner frame 8002 of the window (screen) and component 8003 are created with a label class and a list class, respectively. Then, in a case of a Java AWT class library, it may be possible to say that the number of classes to create the outer frame of the window (screen), such as a frame class, is limited to one.

Likewise, in cases of most current object-oriented programming languages, classes for the outer frame of a window (screen) is limited to one type or at most several types. Therefore, it is possible to extract important scenes that should be recorded as a viewing history element from the program content by paying attention to the special class, like this Java.awt.Frame, which is used every time the window (screen) is changed (the outer frame of the window (screen) is changed).

It is possible to extract a certain state transition that should be recorded as a viewing history element from the program content by, for example, using Java as the programming language; extracting a frame class instance from a program content in a case of using a Java AWT class library; regarding the frame class instance as an important scene (equivalent to a state in a viewing history template); regarding the time the frame class is displayed (at the point Frame.show( )method is called) as the beginning of the state; and regarding the time the frame class is hidden (at the point hide( )method is called) as the end of the states.

That is, even if there is no viewing history template, all these class instances representing the outer frame of the window are extracted and the extracted instances are regarded as states of a viewing history template. Then, it is possible to extract a state transition by regarding the time a class instance representing the outer frame of the window (screen) is actually displayed on the screen (when Frame.show( )method is executed) as the beginning of the state and regarding the time the class instance is hidden (when hide( )method and so forth are called) as the end of the state.

Hereinafter, an example will be shown where a state of a viewing history template is extracted from an actual Java program and where the beginning point to the state and the end point from the state are calculated.

First, the configuration of this apparatus to automatically create viewing history templates is basically the same as the apparatus configuration (see FIG. 1) according to Embodiment 1. Here, although viewing history template 1103 is recorded in advance in optical disc 1100 in Embodiment 1, viewing history template 1103 is not recorded in optical disc 1100 in the present embodiment.

Then, when optical disc 1100 is inserted to optical disc player 1000, program content processing section 1001 reads the content of optical disc 1100 via optical disc access section 1002, and viewing history template 1103 finds that there is no viewing history template 1103 in optical disc 1100, program content processing section 1101 automatically creates viewing history template 1103 from program content 1101. Then, automatically created viewing history template 1103 is stored in file system 1010 as viewing history template 1012 and used to record viewing history generation and analyze viewing histories.

Next, elements of program content 1101 will be shown.

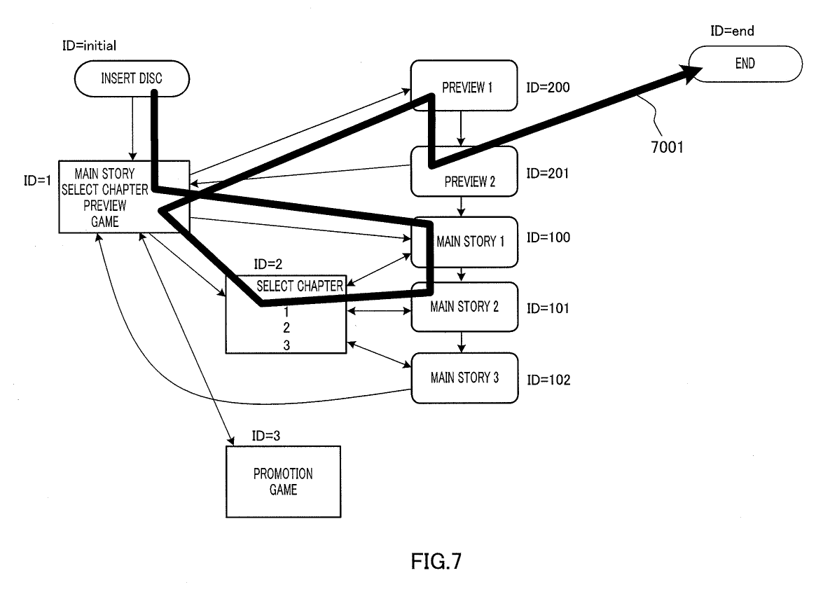

Program content 1101 shown in FIG. 8 is an example of a very simple Java program. The program content according to the present embodiment is formed by byte-compiling this Java program.

This Java program is simplified by eliminating elements unnecessary for explanation from the part related to “main selection screen” (state 2004; ID=1) in Embodiment 1. To be more specific, this program content is displayed on only one screen, which is a chapter selecting screen, and a screen for playback of a moving image content is omitted because it is not necessary for explanation. In addition, the program content has no method of hiding screens because of being displayed on one screen.

FIG. 9 is a drawing schematically showing the screen in which this program content is actually activated and displayed.

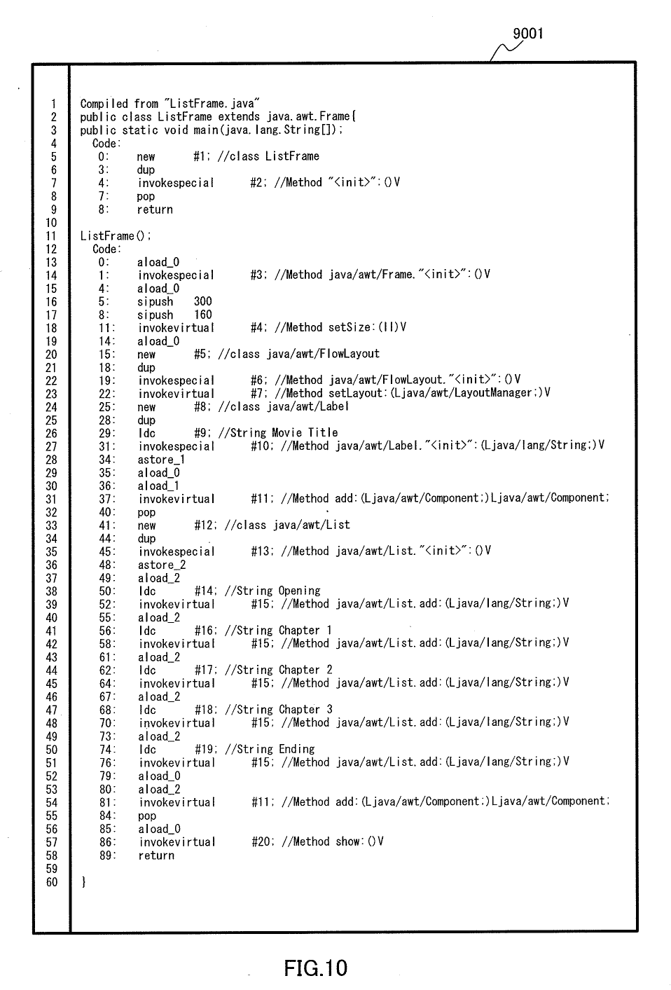

FIG. 10 shows the result of byte-compiled program content 1101 shown in FIG. 8. Here, although the actual byte-compiled result is sequences of numbers, the byte-compiled result in FIG. 10 is expressed in mnemonics in order to allow human to read, for ease of explanation. Here, numbers assigned to the left side of byte-complied result 9001 of FIG. 10 are row numbers added for explanation and are not part of bytecodes.

Now, program content processing section 1001 finds Java.awt.Frame class instance from FIG. 10 and also finds the executing point of the corresponding show( )method, and creates a viewing history template from the point. As described above, program content processing section 1001 creates viewing history templates based on symbol information in bytecodes as a key.

Generally, in case of interpreter implementation (typified by Java implementation), symbol names such as class names and method names understandable by human should be left in bytecodes in order to execute and process the corresponding language. Therefore, it is not difficult to find a frame class and show( ) method from bytecodes, and it is possible to do so by finding the portion in which the class (to be exact, its instance) is generated and by further finding the position of a displaying method such as show( )method from that portion. Then, the found frame class (or its subclass) instance is one of states of a viewing history template and, the time show ( )method is actually executed is the time to start that state.

Likewise, when hiding methods such as hide( ) dispose( ) and so forth to hide the screen are found, the time each hiding method is executed is recorded with the time to end the state. As described above, it is possible to record state transitions by using displaying methods and hiding methods.

Here, note that various pieces of information are left for names and properties of states as many as possible, preferably, in order to be useful in later analysis steps. Not that, for example, names of symbols near show( )method are left for names and properties of states.

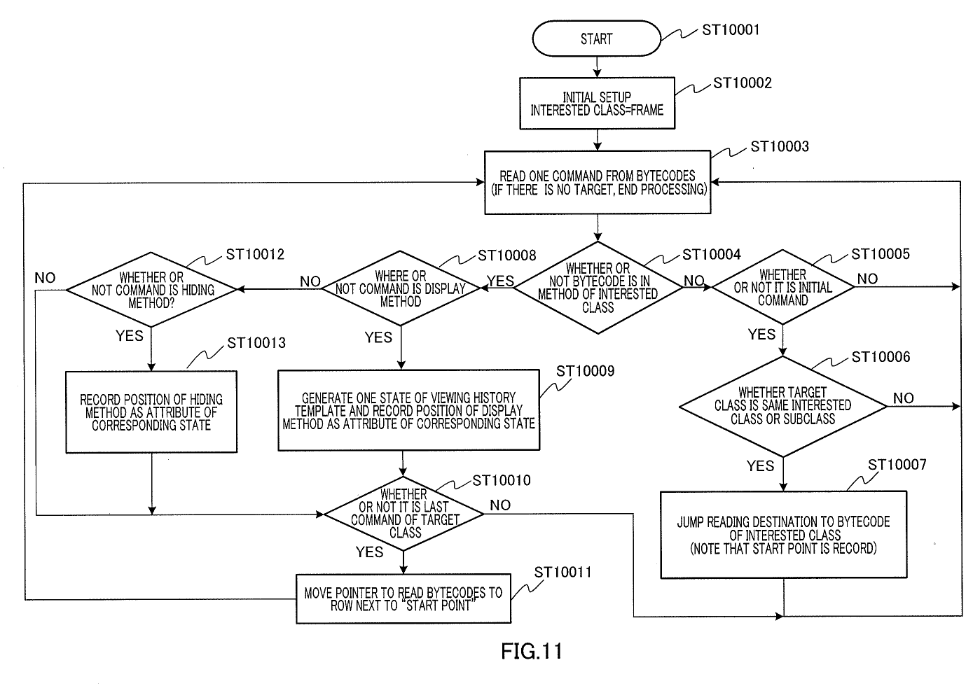

Next, a process will be described here where program content processing section 1001 finds the position where Java.awt.Frame class and its show( )method shown FIG. 10 are executed and then creates a viewing history template, based on these positions. This viewing history template creation is performed following the flowchart shown in FIG. 11.

Now, viewing history template creation will be described flowing to an exemplary program content in FIG. 10.

Program content processing section 1001, first, sets Frame class (and its subclass) as an interested class (ST 10002).

After this, program content processing section 1001 goes on reading bytecodes per command until a interested class appears (until an instance is generated in the program) (repeating ST 10003, ST 10004 and ST 10005).

In FIG. 10 as an example, there is no Java.awt.Frame class itself, it can be understood that a listframe class is a class inheriting Java.awt.Frame, from the second row of byte-compiled result 9001. Therefore, this listframe class is paid attention in FIG. 10.

Here, if continuously going on reading bytecodes, program content processing section 1001 comes upon the portion (command: new) where this listframe class instance is generated in the fifth row. Therefore, although it is basically possible to record a state in the viewing history template by reading commands up to this fifth row, some of the actual classes may be only generated but not be displayed, so that the state is not recorded yet at this time until the display is fixed.

By further going on reading, next, the initialization method of the listframe class instance generated earlier is found (the seventh row of FIG. 10).

Here, decision is made to branch into YES in ST 10005, and also decision is made to branch into YES in ST 10006 because the listframe class is a subclass of the interested class. Here, ST 10007 is executed. First, the start point is recorded as the fourth command of the main method (seventh row of FIG. 10) and then bytecodes of ListFrame method, which is the actual initialization method, is read (note: the name of the initialization method (constructor) and the class name are the same in Java language, and here, “ListFrame” is the method name.) That is, rows subsequent to the thirteenth row of FIG. 10 will be read afterward for a while.

While going on reading commands after the thirteenth row of FIG. 10, program content processing section 1001 skips reading commands in a loop formed by ST 10003, ST 10004, ST 10008, ST 10012, ST 10010 and ST 10003 for a while.

Then, when skipping reading commands up to the fifty-seventh row of FIG. 10, program content processing section 1001 finds show( )method. As a result of this, decision is made to branch into YES in ST 10008, so that here, one state in a viewing history template is created and recorded for the first time (ST 10009).

First, IDs are merely unique numbers, and here, the ID is one. State names are created by adding unique identifiers to identify each instance to class names, and here, the state name is created by adding the ID to the class name. To be more specific, ListFrame #1 is the name of the state recorded in ST 10009.

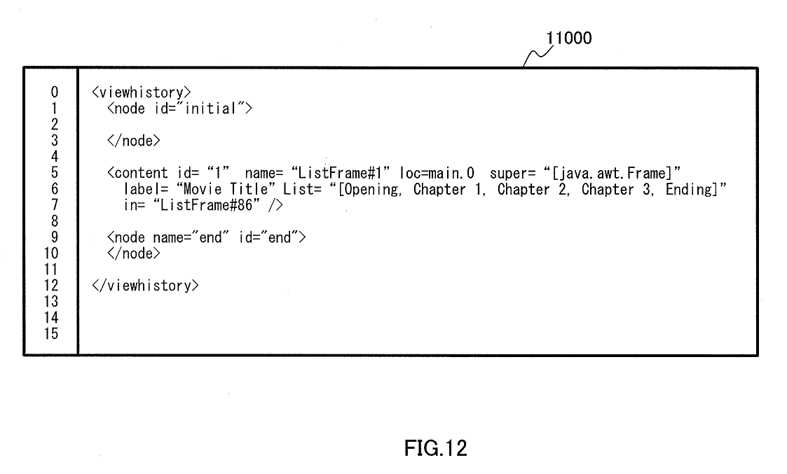

FIG. 12 shows the viewing history template finally created. The ID and the name of the state stored in ST 10009 are added to the fifth row of FIG. 12. Here, in the fifth row, the super class name list (super attribute) of the listframe class and the location in which the listframe class instance is generated (loc attribute; the content is the zeroth command of the main method), in addition to the name and the ID of the state.

In addition to these, as information available from the program content shown in FIG. 10, other graphic object information (attribute: label and list) held in this instance is described in the sixth row.

Then, the position of show( )method in the program content is recorded in the sixth row. This position information is a trigger to record that the state of ListFrame #1 starts when program content processing section 1001 executes the command (the eighty-sixth command of ListFrame( )method) at this position of the program, during processing of this program content later. Then, program content processing section 1001 finally finishes reading the program content shown in FIG. 10 to the end, and as a result of this, viewing history template 11000 shown in FIG. 12 is created.

Here, although the present embodiment is described using an example where the program content is described in Java language, it is possible to produce the same effect in a case in which the program content is described in other languages. In either case, a viewing history may be created by regarding a sequence of similar screen-displayed elements as one state and paying attention to a class and a method in a programming language that implement the state.

As described above, with the present embodiment, classes to express a window (screen) and methods to display/hide these classes in a programming language that implements a program content are paid attention, and on that basis, a viewing history template is created by extracting classes expressing a window (screen) from the program content as states that should be acquired as viewing history elements and recording times to start or end these states using displaying/hiding methods. By this means, it is possible to automatically create a viewing history template to describe states of program content processing section 1001 and links between these states, without human work.

Here, although an example has been described where content media is formed of an optical disc such as a DVD and a Blu-ray disc, media is not limited to a disc and not limited to a form making it possible to read content elements with light. The form of media may be a tape-like form, such as a video cassette tape, and may be a form not having a physical from as a file in a file system used by a computer OS (operating system).

In addition, content element reading methods may not be limited to a method using light but any methods using, for example, magnetism may be possible. For example, contents may be formed of Adobe Flash from Adobe Systems Incorporated and Windows (registered trademark) media video from Microsoft Corporation, which are available by downloading from networks and saving in files.

Moreover, it is possible produce the same effect by file formats executable in specific OSs (e.g. ELF (Executable and Linking Format) files run on a Linux (registered trademark) OS, exe files run on a Windows OS and so forth). In these cases, a content playback apparatus will be realized by combining a content playback application on a general personal computer and the personal computer and its peripheral devices required to play back the content.

The disclosure of Japanese Patent Application No.2009-031909, filed on Feb. 13, 2009, including the specification, drawings and abstract, is incorporated herein by reference in its entirety.

### INDUSTRIAL APPLICABILITY

The present invention makes it possible to generate detailed viewing histories for a commercial Blu-ray disc having a program content including a user interface presenting video and sound contents and is useful to, for example, a DVD player and a Blu-ray disc player.

### REFERENCE SIGNS LIST

1000 optical disc player
1200 remote controller
1001 program content processing section
1002 optical disc accessing section
1003 remote controller input section
1004 operating section
1005 superimposing section
1006 GUI displaying section
1007 moving image and sound playback section
1008 network I/F
1009 viewing history generating section
1010 file system
1011, 6001 viewing history
1012, 1103 viewing history template
1100 optical disc
1101 program content
1102 video, image and sound contents
1400 network
1500 viewing history collecting server
2009 state group
3001, 3002, 11000 viewing history template
8001 outer frame of window (screen)
8002, 8003 inner frame of window (screen)

1. A content media playback apparatus that plays back content media composed of video and sound contents and a program content including a user interface that presents the video and sound contents, the content media playback apparatus comprising:
an access section that reads the content media;
an input section that accepts an operation input from a user;
a program content processing section that reads the program content from the access section and controls playback of the video and sound contents by operating the program content according to the operation input;
a recording section that records a viewing history template to describe states of the program content processing section and links between the states that should be recorded as viewing history elements of the video and sound contents; and
a generating section that generates the viewing history elements using times the program content processing section changes the states described in the viewing history template and the states.

2. The content media playback apparatus according to claim 1,
wherein the viewing history template is recorded on the content media in which the program content is recorded, and copied from the content media to the recording section.

3. The content media playback apparatus according to claim 1,
wherein the viewing history template is stored in a recording device on a network allowed to be accessed from the content media playback apparatus and downloaded from the recording device on the network to the recording section.

4. The content media playback apparatus according to claim 1, wherein:
the program content is described in an object-oriented programming language; and
the viewing history template is created by at least specific classes, methods and symbols of the programming language describing the video and sound contents and the program content.

5. A content media comprising:
video and sound contents;
a program content that includes a user interface presenting the video and sound contents; and
a viewing history template that describes states and transitions between the states that should be recorded as viewing history elements of the video and sound contents, among states of a content media playback apparatus that plays back the video and sound contents and transitions between the states.
